(19) United States
(12) Patent Application Publication
(10) Pub. No.: US 2018/0203707 A1
(43) Pub. Date: Jul. 19, 2018

(54) Context Based Configuration Management

(71) Applicant: International Business Machines Corporation, Armink, NY (US)

(72) Inventors: Aharon Abadi, Petach Tikva (IL); Nili Ifergan - Guy, Haifa (IL); Dmitri Pikus, Haifa (IL); Oleg Sternberg, Haifa (IL); Idan Ben-Harrush, Givat Elah (IL)

(21) Appl. No.: 15/409,559

(22) Filed: Jan. 19, 2017

(51) Int. Cl. G06F 9/445

(52) U.S. Cl. CPC G06F 9/4451

(57) ABSTRACT

A computer implemented method of dynamically configuring a mobile application according to environment context information of the mobile application, comprising using one or more processors for executing a code for collecting a plurality of context information items defining an environment of an application executed on a mobile device associated with a user, extracting according to the plurality of context information items, a plurality of context profiles assigned to the user, each of the plurality of context profiles defines a respective one of a plurality of aspects of the environment and maps a plurality of pre-defined configuration settings of the application, determining an aggregated configuration setting for the application by evaluating a combination of the plurality of configuration settings for the extracted plurality of context profiles and applying automatically the aggregated configuration setting to the application.

### FIELD AND BACKGROUND OF THE INVENTION

The present invention, in some embodiments thereof, relates to dynamically configuring applications executed on a mobile device and, more particularly, but not exclusively, to dynamically configuring applications executed on a mobile device according to a context of a user environment of a user using the application.

The use and spread of mobile devices, for example, Smartphones, tablets, smart watches, smart accessories and/or the like are rapidly increasing.

With the ever increasing mobile devices capabilities, for example, processing power, storage capacity, connectivity, user interaction and the like, the mobile applications executed by the mobile devices also rapidly evolve in functionality, variety, user experience and the like.

The mobile applications are executed in a dynamic environment offered by the mobile devices to their users and may therefore need to adapt to the dynamic nature of their execution, operation and/or usage environment.

### SUMMARY OF THE INVENTION

According to an aspect of some embodiments of the present invention there is provided a computer implemented method of dynamically configuring a mobile application according to environment context information of the mobile application, comprising using one or more processors for executing a code for:
Collecting a plurality of context information items defining an environment of an application executed on a mobile device associated with a user.
Extracting, according to the plurality of context information items, a plurality of context profiles assigned to the user, each of the plurality of context profiles defines a respective one of a plurality of aspects of the environment and maps a plurality of pre-defined configuration settings of the application.
Determining an aggregated configuration setting for the application by evaluating a combination of the plurality of configuration settings for the extracted plurality of context profiles.
Applying automatically the aggregated configuration setting to the application.

According to some embodiments of the invention, each of the plurality of context information items describes a characteristic of one or more aspects of the environment. Each context information item describes one or more members of a group consisting of: a characteristic of the user, an identification of the user, a characteristic of the mobile device, an activity of the user, an action of the user, a location of the user, an interaction of the user with the application, an interaction of the user with one or more other users and an interaction of the user with one or more other devices.

According to some embodiments of the invention, the plurality of context information items is collected from one or more sources. The one or more sources are members of a group consisting of: a sensor of the mobile device, a clock of the mobile device, an external device connected to the mobile device, information available in the mobile device, an interaction of the user with the application and an interaction of the user with the mobile device.

According to some embodiments of the invention, one or more of the plurality of context information items are user inserted context information items.

According to some embodiments of the invention, each context profile defines a plurality of values for one or more characteristics of the user and/or the application while used by the user with respect to the respective aspect.

According to some embodiments of the invention, one or more of the collecting, the extracting and the determining is performed locally at the mobile device.

According to some embodiments of the invention, one or more of the collecting, the extracting and the determining is performed remotely from the mobile device, and wherein the applying includes transmitting the aggregated configuration setting to the mobile device that applies the aggregated configuration setting to the application.

According to some embodiments of the invention, the aggregated configuration setting is determined according to at least a subset of the plurality of configuration settings.

According to some embodiments of the invention, the aggregated configuration setting is determined according to the plurality of configuration settings of at least a subset of the plurality of context profiles.

Optionally, according to some embodiments of the invention, the one or more processors are adapted to assign weights to one or more of the plurality of context profiles to define a priority for one or more context profiles with respect to one or more other context profiles of the plurality of context profiles.

Optionally, according to some embodiments of the invention, the one or more processors are adapted to execute code for generating one or more new configuration settings for one or more of the plurality of context profiles according to one or more usage patterns of the user identified by monitoring a usage of the application by the user.

According to an aspect of some embodiments of the present invention there is provided a system for dynamically configuring a mobile application according to environment context information of the mobile application, comprising one or more processors adapted to execute a code, the code comprising:
Code instructions to collect a plurality of context information items relating to an environment of an application executed on a mobile device associated with a user.
Code instructions to extract, according to the plurality of context information items, a plurality of context profiles assigned to the user. Each of the plurality of context profiles defines a respective one of a plurality of aspects of the environment and maps a plurality of pre-defined configuration settings of the application.
Code instructions to determine an aggregated configuration setting for the application by evaluating a combination of the plurality of configuration settings for the extracted plurality of context profiles.
Code instructions to apply automatically the aggregated configuration setting to the application.

According to an aspect of some embodiments of the present invention there is provided a computer program product for dynamically configuring a mobile application according to environment context information of said mobile application, comprising:
A non-transitory computer readable storage medium.
First program instructions for collecting a plurality of context information items relating to an environment of an application executed on a mobile device associated with a user.
Second program instructions for extracting, according to the plurality of context information items, a plurality of context profiles assigned to the user. Each of the plurality of context profiles defines a respective one of a plurality of aspects of the environment and maps a plurality of pre-defined configuration settings of the application.
Third program instructions for determining an aggregated configuration setting for the application by evaluating a combination of the plurality of configuration settings for the extracted plurality of context profiles.
Fourth program instructions for applying automatically the aggregated configuration setting to the application.
   Wherein the first, second, third and fourth program instructions are executed by one or more processors from the non-transitory computer readable storage medium.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process for dynamically configuring a mobile application according to an environmental context of a user using the mobile application, according to some embodiments of the present invention;

FIG. 2 is a schematic illustration of an exemplary system for dynamically configuring locally a mobile application according to an environmental context of a user using the mobile application, according to some embodiments of the present invention; and

FIG. 3 is a schematic illustration of an exemplary system for dynamically configuring remotely a mobile application according to an environmental context of a user using the mobile application, according to some embodiments of the present invention.

### DESCRIPTION OF SPECIFIC EMBODIMENTS OF THE INVENTION

The present invention, in some embodiments thereof, relates to dynamically configuring applications executed on a mobile device and, more particularly, but not exclusively, to dynamically configuring applications executed on a mobile device according to a context of a user environment of a user using the application.

According to some embodiments of the present invention, there are provided methods, systems and computer program products for dynamically configuring a mobile application according to an environmental context of a user using the mobile application. By collecting a plurality of context information items describing one or more context aspects of the user environment while using the (mobile) application, the application may be dynamically and automatically configured to adapt according to the environmental context. The context information items may include, for example, a mobile device type, a capability of the mobile device, an interaction of the user with one or more other users, an interaction of the application with one or more other applications and/or services, a usage preference of the mobile device, an interaction of the user with the mobile device, a geographical location of the user, an activity the user is involved in, an operation of the user, a network connection type used by the mobile device and/or the like. The context information items may be collected from one or more of a plurality of sources, for example, a sensor of the mobile device, a clock, an external device connected to the mobile device, analysis of interaction of the user with one or more applications, services, devices and/or users, analysis of information available in the mobile device, user inserted information and/or the like.

One or more context profiles each defining an aspect of the user environment may be extracted for each of the collected context information items. Each context profile defines one or more characteristics of the user and/or the application with respect to the aspect of the context profile. The context profiles may include, for example, a geographical location profile, a timing profile, an activity profile, an action profile, a user information profile, a user interaction profile, a network connection profile and/or the like. Each of the context profiles maps one or more pre-defined configuration settings for the application. The configuration settings mapped by each of the extracted context profiles are evaluated jointly to select an aggregated profile setting to be applied automatically to the application.

Optionally, one or more usage patterns of the user using the application are identified by monitoring interaction between the user and the mobile device and/or the application. Based on the identified usage patterns, one or more additional configuration settings may be generated and mapped by one or more of the context profiles for configuring the application.

Dynamically configuring an application executed on a mobile device according to the context of the execution environment may present significant advantages. First, the user experience may be significantly improved since the application may be configured to present a user interface that may better suit one or more contextual aspects of the user environment. The user interaction may be adapted dynamically and automatically according to the context, activity and/or conditions of the user environment making it simpler for the user to interact with the application. Additionally, the dynamically configuring of the application according to the context may serve a plurality of application vendors to offer better serviceability to the user according to the dynamically changing user environment. The application vendors may various configurations to present content, for example, commercial content, organizational content, service content and/or the like to the user to match the context of the user environment, activity and/or operation(s). The dynamic configuration of the application may further reduce resources consumption of the mobile device by adapting to one or more context aspects of the user. For example, computation resources of the mobile device may be significantly reduced by configuring an active application to avoid computations not currently required due to the context, activity and/or interaction of the user. In case for example, the user is currently holding a phone call, no data communication may be required thus reducing computation, storage and/or networking resources.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

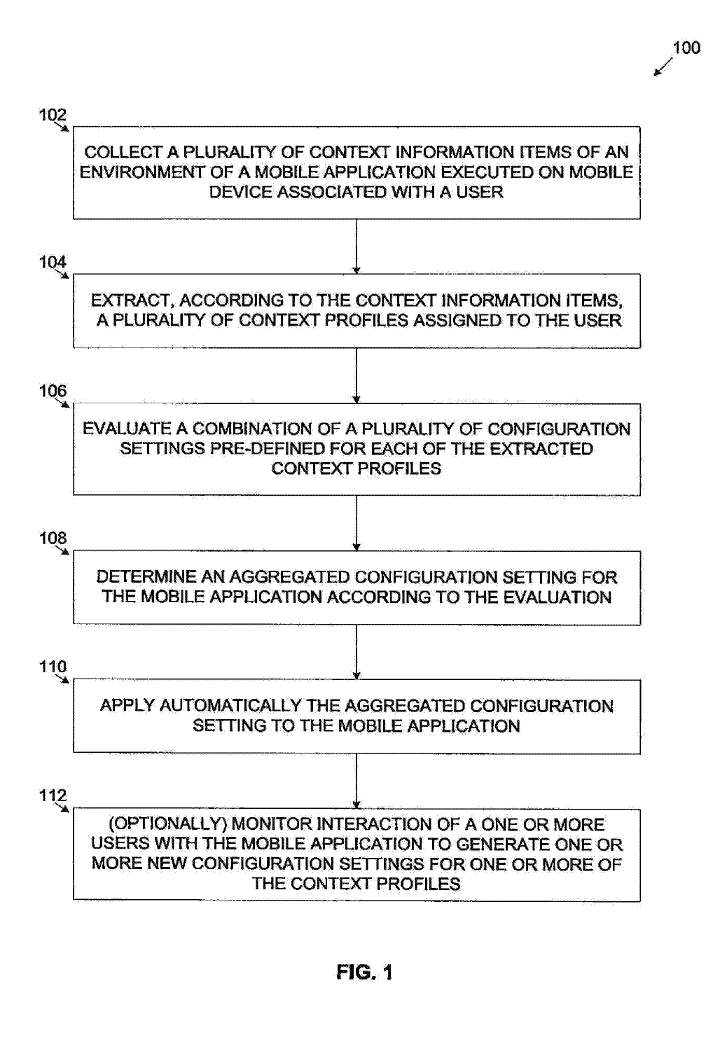

Referring now to the drawings, FIG. 1 illustrates a flowchart of an exemplary process for dynamically configuring a mobile application according to an environmental context of a user using the mobile application, according to some embodiments of the present invention. A process 100 may be executed to dynamically configure one or more settings of one or more applications executed on one or more mobile devices used by one or more users according to context information collected for one or more environmental aspects and/or characteristics of the user while using the application. In some embodiments of the present invention, the dynamic configuration may be determined and applied locally by the mobile device itself while in some embodiments of the present invention the dynamic configuration may be determined remotely, for example, by a service provider of the application and transmitted to the mobile device that applies the configuration. A combination of the remote and local implementation may also apply in which some of the functionality of the process 100 may be carried out by the mobile device while some of the functionality of the process 100 may be done remotely. Naturally, the process 100 may be used for a plurality of users using a plurality of applications on a plurality of mobile devices, however for brevity the process 100 is described for a single application executed on a single mobile device.

The process is based on collecting one or more context information items describing one or more context aspects of the user environment while using the application, for example, a mobile device type, a capability of the mobile device (e.g. a GPS, a Bluetooth connection, etc.), an interaction with one or more other users, a usage preference of the mobile device, an interaction with the mobile device, a geographical location of the user, a network connection type and/or the like. One of a plurality of context profiles is extracted for each of the collected context information items. Each context profile defines a plurality of values for one or more characteristics of the user and/or the application while used by the user with respect to a specific aspect associated with the context profile. The context profile(s) may be extracted by comparing the collected context information items for each context aspect with respect to the characteristic(s) defined by the respective context profile. Each of the context profiles maps one or more pre-defined configuration settings for the application. Based on evaluation of a combination of the configuration settings that is identified for each of the extracted context profiles an aggregated profile setting is determined and applied to the application at the mobile device.

Optionally, one or more usage patterns of the user using the application are identified by monitoring interaction between the user and the mobile device and/or the application. Based on the identified usage patterns, one or more additional configuration settings may be generated for the application.

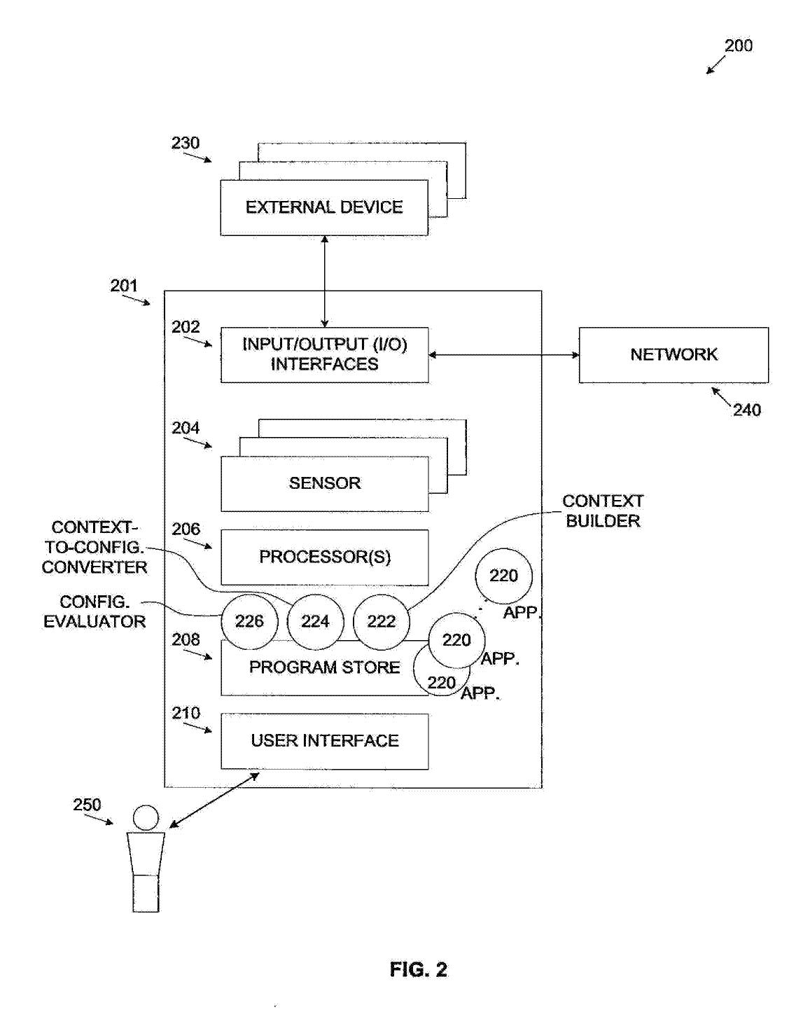

Reference is now made to FIG. 2, which is a schematic illustration of an exemplary system for dynamically configuring locally a mobile application according to an environmental context of a user using the mobile application, according to some embodiments of the present invention. A system 200 for executing a mobile application dynamic configuration process such as the process 100 comprises a mobile device 201, for example, a Smartphone, a tablet, a smart watch, a laptop and/or the like. The mobile device 201 includes an input/output (I/O) interface 202 for connecting to one or more external devices 230, one or more sensors 204, a clock 205, a processor(s) 206, a program store 208 and a user interface 210 for interacting with a user 250. The I/O interface may provide one or more interconnect interfaces, for example, a Bluetooth interface, a network interface, a serial interface, a Universal Serial Bus (USB) interface, a memory management controller (MMC) interface and/or the like. The network interface may support one or more wireless network interfaces for connecting to one or more networks 240, for example, a Wireless Local Area Network (WLAN) (e.g. Wi-Fi), a cellular network interface and/or the like. The network interface may further support one or more wired network interfaces, for example, a Local Network Interface (LAN), a Controller Area Network (CAN) interface and/or the like. The sensor(s) 204 may include one or more sensing devices, for example, a GPS sensor, a temperature sensor, a humidity sensor, an accelerometer, a gyroscope, an altitude sensor and/or the like. The clock 205 include one or more time keeping devices, for example, a clock, a real time clock (RTC), a counter, a timer and/or the like. The processor(s) 206, homogenous or heterogeneous, may be arranged for parallel processing, as clusters and/or as one or more multi core processor(s). The program store 208 may include one or more non-transitory persistent storage devices, for example, a Flash array, a Solid State Disk (SSD) and/or the like. The program store 206 may further be utilized through one or more volatile memory devices, for example, a Random Access Memory (RAM) device used to store program code downloaded from one or more remote locations over the I/O interface 202. The user interface 210 may include a one or more human-machine interfaces, for example, a text interface, a pointing devices interface, a touch surface, a display, an audio interface and/or the like. The user interface 208 may be used to present, for example, a graphic user interface (GUI) utilized through the human-machine interface(s). The external devices 230 may include one or more sensors such as the sensors 204, one or more other mobile devices such as the mobile device 201. The external devices 230 may also include one or more other devices, for example, a smart home system, a security system, and/or the like. The external devices 230 may further include one or more devices and/or services provided by one or more remote processing nodes, for example, a server, a cloud service, a website and/or the like available over the network(s) 240.

The processor(s) 206 may execute one or more one or more software modules, for example, an application 220 (mobile application) each comprising a plurality of program instructions executed by the processor(s) 206 from the program store 206. Wherein a software module may be, for example, a process, an application, a utility and/or the like that comprising a plurality of program instructions stored in a non-transitory medium such as the program store 208 and executed by a processor such as the processor(s) 206.

The process 100 may be executed locally by one or more software modules, for example, a context builder 222, a context-to-configuration converter 224, a configuration evaluator 226 and/or the like for dynamically configuring one or more of the applications 220. The context builder 222 and/or the context-to-configuration converter 224 may be integrated within one or more of the dynamically configured application 220 and/or they may be external software modules executed by the processor(s) 206 on the mobile device 201.

In some embodiments the process 100 is executed remotely with the aggregated configuration setting transmitted to the mobile device 201 that may apply the aggregated configuration setting to a respective one of the applications 220.

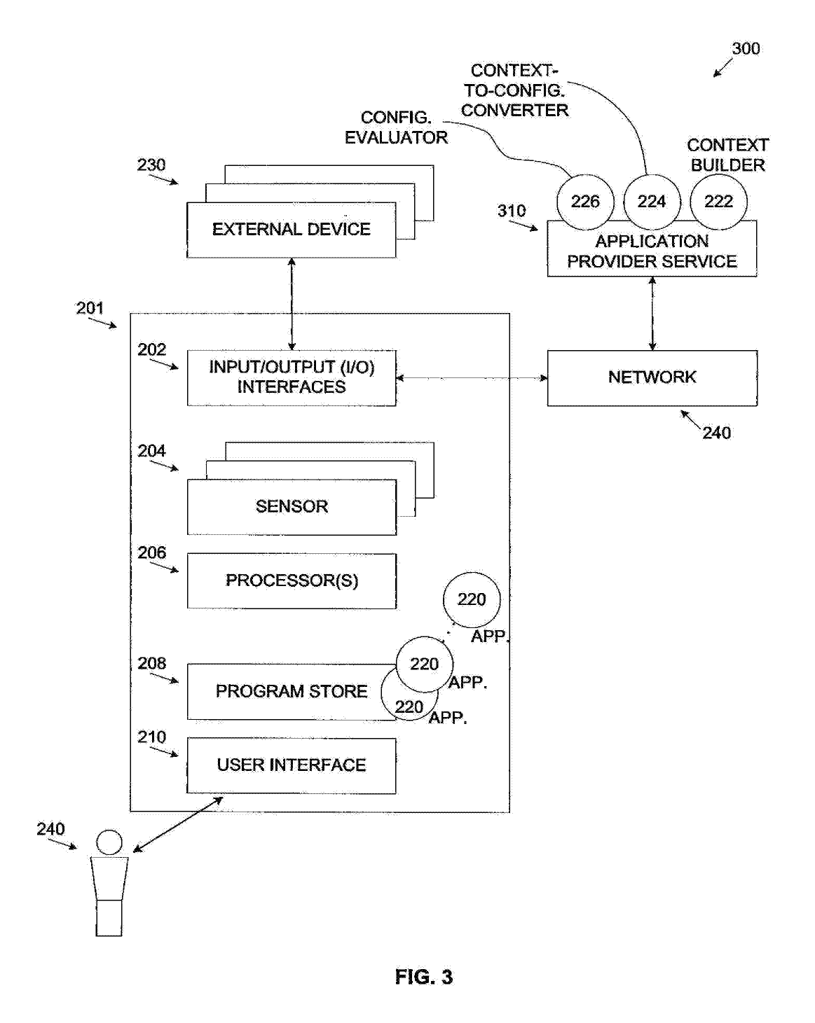

Reference is also made to FIG. 3, which is a schematic illustration of an exemplary system for dynamically configuring remotely a mobile application according to an environmental context of a user using the mobile application, according to some embodiments of the present invention. A system 300 for executing a mobile application dynamic configuration process such as the process 100 comprises a mobile device such as the mobile device 201 and one or more application provider(s) service(s) 310 provided through one or more remote servers, websites, cloud services, and/or the like that may communicate with the mobile device 201 over one or more of the networks 240. One or more of the software modules for performing the process 100, for example, the context builder 222, the context-to-configuration converter 224 and/or the configuration evaluator 226 may be executed by the application provider service(s) 310 may execute. The application provider service(s) 310 may receive one or more context information items from the mobile device 201 and may transmit the aggregated configuration setting to the mobile device 201 that may apply the aggregated configuration setting to the respective application 220.

While the process 100 may be executed entirely by the processor(s) 206 of the mobile device 201, executed entirely by the application provider service(s) 310 and/or a combination thereof, the process 100 is executed similarly and is described herein after independent of the executing entity.

Reference is made once again to FIG. 1. The process 100 may be executed by a mobile device such as the mobile device 201 (as in the system 200) and/or by an application provider service(s) such as the application provider service(s) 310 (as in the system 300) for dynamically configuring one or more applications (mobile applications) such as the application 220 used by a user such as the user 250. The process 100 executed for example, by the context builder 222, the context-to-configuration converter 224 and/or the configuration evaluator 226 may be continuously executed to identify changes in the context of the environment of the user 250 using the application 220.

As shown at 102, one or more software modules, for example, the context builder 222 may collect one or more context information items describing one or more characteristics of one or more context aspects of the environment of the user 250 while using the application 220 executed on the mobile device 201. The context information items may include for example, a type of the mobile device 201, a capability of the mobile device 201, an interaction of the user 250 with the application 220, an interaction of the user 250 with the mobile device 201, an interaction of the application 220 with one or more other users such as the user 250 using one or more mobile devices such as the mobile device 201, a usage preference of the user 250 with the mobile device 201, a geographical location of the user 250, a network connection type of the mobile device 201 and/or the like. The context builder 222 may identify one or more group context characteristics of the user 250, for example, an association with one or more groups of users 250, a subscription to a social network and/or the like. The context builder 222 may further identify a field of interest of the user 250, an activity the user 250 is involved in (in the present, the past and/or the future), an action performed by the user 250 and/or the like.

The context builder 222 may collect the context information items from one or more of a plurality of sources, for example, the sensor(s) 204, an external device such as the external device 230 and/or the like. For example, the context builder 222 may a geographical location of the user 250, for example, at home, at work, in a vehicle and/or the like by analyzing information received for example, from the GPS sensor, the accelerometer, the gyroscope and/or the like. The context builder 222 may also analyze information received from one or more of the external devices 230, for example, a Radio Frequency Identification (RFID) presence reader located at an office of the user 250 to determine the geographical location of the user 250. As another example, the context builder 222 may collect location information from one or more base stations serving the mobile device 201 with a cellular network service. The context builder 222 may identify the current time and/or date by accessing the clock 205.

The context builder 222 may analyze the interaction of the user 250 with one or more of the applications 220, an interaction with the mobile device itself and/or interaction with one or more of the other users 250 to identify an operation the user 250 performs and/or an activity the user 250 is involved in. For example, the context builder 222 may analyze the interaction of the user 250 with a social network application and determine that the user is currently chatting with one or more other users 250. In another example, the context builder 222 may identify the geographical location of the user 250 by analyzing information retrieved from a navigation application currently used by the user 250. As another example, the context builder 222 may identify that a plurality of users 250 of a group, in which the user 250 is a member, are currently located at the same geographical location and determine that a group activity is in progress.

The context builder 222 may analyze the interaction of the user 250 using the with one or more of the applications 220 and/or with the mobile device itself to identify an operation the user 250 performs and/or an activity the user 250 is involved in. For example, the context builder 222 may analyze the interaction of the user 250 with a social network application and determine that the user is currently chatting with one or more other users 250. Based on the analysis of the interaction of the user 250, the context builder 222 may further identify one or more usage characteristics of the mobile device 201 by the user 250. For example, the context builder 222 may detect that the user 250 prefers texting to the other users 250 using a texting application rather than having phone conversations using a phone call application. In another example, the context builder 222 may further detect that the user 250 prefers a specific texting application over other texting applications.

The context builder 222 may further analyze information inserted by the user 250 to the mobile device 201 through one or more of the applications 220, for example, a calendar application, a tasks manager application and/or the like to detect an activity the user 250 is currently involved with. For example, analyzing one or more entries in the calendar application, the context builder 222 may determine that the user 250 is currently in a sports event, at a party, shopping in a mall and/or the like. In another example, by analyzing information inserted by the user 250 while creating his user profile for use in one or more of the applications 220, the context builder 222 may identify one or more personal information aspects of the user 250, for example, an age, a job position, a field of interest, a hobby, a music preference, a fashion preference and/or the like.

In case the process 100 is executed entirely and/or partially by an application provider service(s) such as the application provider service(s) 310 in the system 300, the context builder 222 may send one or more of the collected context information items to the application provider service(s) 310.

As shown at 104, the context builder 222 extracts one or more context profiles corresponding to the collected context information item(s). Each context profile may define a plurality of values for one or more characteristics of the user 250 and/or the application 220 while used by the user 250 with respect to a specific aspect associated with the context profile. Each context profile is considered an atomic profile meaning it may be associated with a single context aspect of the environment of the user 250 that may also be considered as the execution environment of the application 220 that is dynamically configured. The context profiles may include, for example, a mobile device profile, a geographical location profile, a timing profile, an activity profile, an action profile, a user information profile, a user interaction profile, a network connection profile and/or the like. The context builder 222 may extract one or more of the context profiles relating to the dynamically configured application 220 that may be identified based on the collected context information item(s). The context builder 222 may extract the context profile(s) by comparing the values of the collected context information items for each context aspect with respect to the values of the characteristic(s) defined by the respective context profile. For example, in case the geographical location of the user 250 is detected and the dynamically configured application 220 includes a geographical location context profile, the context builder may extract the geographical location context profile of the application 220.

As shown at 106, one or more software modules, for example, the context-to-configuration converter 224 may evaluate a plurality of pre-defined configuration settings mapped by the extracted context profile(s). Each of the context profiles maps one or more pre-defined configuration settings for the application 220. The pre-defined configuration settings may define one or more aspects and/or characteristics of the application 220, for example, layout, color(s), content and/or the like.

For example, in a shopping application, a price field color may be changed for a deal period based on the timing profile, for example, a part of the year (date). A price value in the price field may also be adjusted according to the user information profile comprising, for example, customer type information, such that, for example, a premium customer may be offered with special offers and/or lower prices. The of customer type information, for example, the premium customer, a returning customer, an anonymous customer and/or the like may also be identified according to previous visit records available, for example, by the application provider service 310 of the shopping application. Based on the customer type, the shopping application may be configured with different layouts, colors and/or content.

In another example, in an enterprise application, an employee role and/or position that may be available from, for example, the user information profile may be used to configure the content and/or the layout of the enterprise application presented to the user(s) 250 of the mobile device(s) 201.

In another example, in a banking application, a user identity that may be available from, for example, the user information profile and/or a network connection type that may be available from, for example, the connection profile may be used to configure the content and/or the layout of the banking application presented to the user(s) 250.

In another example, in a military enterprise application, one or more secret modules may not be exposed to the mobile device 201 at any time of the military enterprise application lifecycle. For specific user(s) 250, according to their identity information that may be available from, for example, the user information profile and/or a network connection type that may be available from, for example, the connection profile, the military enterprise application may be configured to load the secret module(s) at runtime to be executed in a secure container.

In another example, in a communication application, the content and/or the layout of the communication application may be adjusted according to one or more context profiles, for example, the connection profile and/or the geographical location profile. The connection profile may include a plurality of pre-defined configuration settings, for example, office Wi-Fi, home Wi-Fi, cellular data and/or the like. The geographical location profile may include a plurality of pre-defined configuration settings, for example, home, office, on-way to office, on-way home and/or the like.

Optionally, the context-to-configuration converter 224 evaluates the pre-defined configuration settings mapped by a subset of the extracted context profiles. This means that the context-to-configuration converter 224 may evaluate only part of the extracted context profiles.

Optionally, the context-to-configuration converter 224 evaluates only a subset of the pre-defined configuration settings mapped by one or more of the extracted context profiles. This means that the context-to-configuration converter 224 may evaluate only part of the pre-defined configuration settings associated with the extracted context profile(s).

As shown at 108, based on the evaluation of the pre-defined configuration settings mapped by the extracted context profiles, the context-to-configuration converter 224 may determine an aggregated configuration setting to be applied to the application 220. Since each of the extracted context profiles may map a different configuration setting for the application 220, the context-to-configuration converter 224 may need to determine, based on the evaluation, the aggregated configuration setting for the application 220 by combining one or more of the configuration settings mapped by the extracted context profiles. The aggregated configuration setting may be, for example, an intersection of the pre-defined configuration settings mapped by the extracted context profile(s), a combination of the pre-defined configuration settings mapped by the extracted context profiles and/or the like. For example, assuming the context profiles are designated Pi {P1, . . . , Pn} with each of the context profiles Pi mapping a set of Si pre-defined configurations Ci such that Si={Ci1, . . . , Cini}. The context-to-configuration converter 224 may determine the aggregated configuration setting as the intersection between S1, . . . , Sn. As another example, one or more of the pre-defined configuration settings of one or more of the context profiles may configure only a portion of the application 220 as presented to the user 250, for example, an additional content, a color of one or more fields, a portion of the presented layout. The context-to-configuration converter 224 may determine the aggregated configuration setting is a combination of two or more of the pre-defined configuration settings of the context profile(s) such that the application 220 is applied with several configuration elements induced by different context profiles.

The aggregated configuration setting may also comprise only a partial configuration derived from the pre-defined configuration settings mapped by the extracted context profiles. For example, the intersection between S1, . . . , Sn may be an empty group, i.e. no valid configuration settings are common to the extracted context profiles. However, one or more of the pre-defined configuration settings may contain common sub-configuration settings defining only a partial configuration. The context-to-configuration converter 224 may use the sub-configuration settings as new configuration settings mapped by the respective context profiles.

Optionally, the context-to-configuration converter 224 assigns weights to one or more of the extracted context profiles such that they may have a priority over one or more other extracted context profiles. For example, in the shopping application, the user information profile containing, for example, the customer identification information may have a priority over the geographical context profile.

As shown at 110, the aggregated configuration setting is applied automatically to the application 220. As discussed before, in case the context-to-configuration converter 224 is executed remotely, the context-to-configuration converter 224 may transmit a command indicating the application 220 of the aggregated configuration setting to be applied. The transmitted command may include the aggregated configuration setting itself and/or an instruction to the application 220 to retrieve the aggregated configuration setting from a local store such as for example, the program store 208.

For example, a first user such as the user 250 walks into a mall and launches a shopping application 220 provided by the shopping mall. The context builder 222 may collect a plurality of context information items, for example, the geographical location of the first user 250, the current time of day, the type of the mobile device 201 used by the first user 250 and/or the like. The context builder 222 may further retrieve purchasing information of the first user 250 with respect to the shopping mall. The context builder 222 may retrieve the purchasing information from a purchasing history stored in the mobile device 201 and/or from one or more history records available from the application provider service 310. The context builder 222 may then extract one or more context profile according to the collected context information items, for example, the mobile device profile, the geographical location profile, the activity profile, the user information profile and/or the like. Each of the extracted context profiles may map one or more configuration settings for the shopping application 220. The context-to-configuration converter 224 may evaluate the pre-defined configuration settings mapped by each of the extracted context profiles. For example, a configuration setting that presents the shops available in the shopping mall may be mapped by the geographical location profile, a configuration setting that displays the contents in a certain display resolution may be mapped by the mobile device profile, a configuration setting that highlights special offers in specific shop(s) in the shopping mall may be mapped by the user information profile of the first user 250 according to the purchasing information and/or the like. Based on the evaluation, the context-to-configuration converter 224 may determine the aggregated configuration setting, for example, presenting the special deals at the specific shop(s) at the certain resolution supported by the mobile device 201. The context-to-configuration converter 224 may further select a configuration setting of the shopping application 220 comprising a high resolution video clip banner in case the mobile device profile of the first user 250 indicates the mobile device 201 of the first user 250 is capable of supporting the certain resolution. The aggregated configuration setting may then be applied to the shopping application 220 executed by the mobile device 201 of the first user 250.

The same process may be applied by the context builder 222 and the context-to-configuration converter 224 may apply the same process for a second user 250. The second user 250 may have a different mobile device 201 and therefore the context information item(s) relating to the mobile device characteristics may differ from those collected for the first user 250. Similarly, the purchasing history may be different for the second user 250 compared to the first user 250. While the extracted profile may be similar or not (to the first user 250), naturally the pre-defined configuration settings mapped by the extracted profiles, for example, the mobile device profile and/or the user information profile may be different. For example, assuming the mobile device 201 of the second user does not support playing the high resolution video clip, a different configuration setting in which a text message is presented may be mapped by the mobile device profile of the second user 250. As another example, the configuration settings mapped by the extracted context profiles for the second user 250 may indicate purchasing history at different shop(s) than those of the first user 250. As result the configuration settings evaluated by the context-to-configuration converter 224 for the second user 250 may be different than those evaluated for the first user. The aggregated configuration setting may then be applied to the shopping application 220 executed by the mobile device 201 of the second user 250.

This example, exhibits the way the shopping application 220 specifically and any of the applications 220 in general may be dynamically adapted with pre-defined configuration settings according to different context information items collected for the contextual environment of the user 250 and/or the application 220.

As shown at 112, which is an optional step, one or more software modules, for example, the configuration evaluator 226, may monitor usage of the mobile device 201 and/or the application 220 by the user 250 to identify one or more usage patterns. The configuration evaluator 226 may add and/or generate one or more new configuration settings for one or more of the context profiles according to the identified usage pattern(s). The configuration evaluator 226 may then instruct the context-to-configuration converter 224 to map the newly added/generated configuration setting in the respective context profile. For example, based on usage of the user 250 with the shopping application, the configuration evaluator 226 may create a usage pattern indicating the user 250 may be a premium customer of the shop operating the shopping application (either online shop and/or a physical shop). Based on the detected usage pattern one or more of the context profiles, for example, the user information profile may be updated to map a newly added and/or generated premium customer configuration setting.

The configuration evaluator 226 may further identify one or more usage pattern(s) of one or more groups of users 250. For example, the configuration evaluator 226 may identify that a certain group of users 250 that are employees of a certain company never use a specific feature defined by the current configuration setting of their organization application. The configuration evaluator 226 may generate a new configuration setting excluding the unused feature and may instruct the context-to-configuration converter 224 to map the newly generated configuration setting in the user information profile of the users 250 that are members of the specific group.

It is expected that during the life of a patent maturing from this application many relevant mobile application methodologies will be developed and the scope of the term mobile application is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A computer implemented method of dynamically configuring a mobile application according to environment context information of said mobile application, comprising:
using at least one processor for executing a code for:
collecting a plurality of context information items defining an environment of an application executed on a mobile device associated with a user;
extracting, according to said plurality of context information items, a plurality of context profiles assigned to said user, each of said plurality of context profiles defines a respective one of a plurality of aspects of said environment and maps a plurality of pre-defined configuration settings of said application;
determining an aggregated configuration setting for said application by evaluating a combination of said plurality of configuration settings for said extracted plurality of context profiles; and
applying automatically said aggregated configuration setting to said application.

2. The computer implemented method of claim 1, wherein each of said plurality of context information items describes a characteristic of at least one aspect of said environment, said each context information item describes at least one member of a group consisting of: a characteristic of said user, an identification of said user, a characteristic of said mobile device, an activity of said user, an action of said user, a location of said user, an interaction of said user with said application, an interaction of said user with at least one other user and an interaction of said user with at least one other device.

3. The computer implemented method of claim 1, wherein said plurality of context information items is collected from at least one source, said at least one source is a member of a group consisting of: a sensor of said mobile device, a clock of said mobile device, an external device connected to said mobile device, information available in said mobile device, an interaction of said user with said application and an interaction of said user with said mobile device.

4. The computer implemented method of claim 1, wherein at least one of said plurality of context information items is a user inserted context information item.

5. The computer implemented method of claim 1, wherein said each context profile defines a plurality of values for at least one characteristic of: said user and said application while used by said user, with respect to said respective aspect.

6. The computer implemented method of claim 1, wherein at least one of said collecting, said extracting and said determining is performed locally at said mobile device.

7. The computer implemented method of claim 1, wherein at least one of said collecting, said extracting and said determining is performed remotely from said mobile device, and
wherein said applying includes transmitting said aggregated configuration setting to said mobile device that applies said aggregated configuration setting to said application.

8. The computer implemented method of claim 1, wherein said aggregated configuration setting is determined according to at least a subset of said plurality of configuration settings.

9. The computer implemented method of claim 1, wherein said aggregated configuration setting is determined according to said plurality of configuration settings of at least a subset of said plurality of context profiles.

10. The computer implemented method of claim 1, wherein said at least one processor is further adapted to assign weights to at least one of said plurality of context profiles to define a priority for said at least one context profile with respect to at least one other context profile of said plurality of context profiles.

11. The computer implemented method of claim 1, wherein said at least one processor is further adapted to execute code for generating at least one new configuration setting for at least one of said plurality of context profiles according to at least one usage pattern of said user identified by monitoring a usage of said application by said user.

12. A system for dynamically configuring a mobile application according to environment context information of said mobile application, comprising:
at least one processor adapted to execute a code, said code comprising:
code instructions to collect a plurality of context information items relating to an environment of an application executed on a mobile device associated with a user;
code instructions to extract, according to said plurality of context information items, a plurality of context profiles assigned to said user, each of said plurality of context profiles defines a respective one of a plurality of aspects of said environment and maps a plurality of pre-defined configuration settings of said application;
code instructions to determine an aggregated configuration setting for said application by evaluating a combination of said plurality of configuration settings for said extracted plurality of context profiles; and
code instructions to apply automatically said aggregated configuration setting to said application.

13. A computer program product for optimizing server coverage of dynamically configuring a mobile application according to environment context information of said mobile application, comprising:
a non-transitory computer readable storage medium;
first program instructions for collecting a plurality of context information items relating to an environment of an application executed on a mobile device associated with a user;
second program instructions for extracting, according to said plurality of context information items, a plurality of context profiles assigned to said user, each of said plurality of context profiles defines a respective one of a plurality of aspects of said environment and maps a plurality of pre-defined configuration settings of said application;
third program instructions for determining an aggregated configuration setting for said application by evaluating a combination of said plurality of configuration settings for said extracted plurality of context profiles; and
fourth program instructions for applying automatically said aggregated configuration setting to said application;
wherein said first, second, third and fourth program instructions are executed by at least one processor from said non-transitory computer readable storage medium.
